(19) United States
(12) Patent Application Publication
(10) Pub. No.: US 2024/0113520 A1
(43) Pub. Date: Apr. 4, 2024

(54) ENERGY CONSUMPTION PREDICTION DEVICE, ENERGY CONSUMPTION PREDICTION METHOD, AND ENERGY CONSUMPTION PREDICTION PROGRAM

(71) Applicant: IHI CORPORATION, Tokyo (JP)

(72) Inventors: Yuji KOGUMA, Tokyo (JP); Kenichi HAMAGUCHI, Tokyo (JP); Akinobu INAMURA, Tokyo (JP); Sho KAZIKURA, Tokyo (JP)

(73) Assignee: IHI CORPORATION, Tokyo (JP)

(21) Appl. No.: 18/276,726

(22) PCT Filed: May 31, 2022
(86) PCT No.: PCT/JP2022/022167

§ 371 Date: Aug. 10, 2023

(30) Foreign Application Priority Data
Jun. 2, 2021 (JP) 2021-092915

(51) Int. Cl. H02J 3/00

(52) U.S. Cl. CPC H02J 3/003

(57) ABSTRACT

An energy consumption prediction device includes: a storage unit configured to store past energy consumption result data of a target facility in correlation with information for identifying a date and time at which the data has been acquired and incidental information which is information related to an operation situation of the target facility when the data has been acquired; an extraction unit configured to extract data in which the incidental information matches an extraction condition designated by a user from the energy consumption result data stored in the storage unit and to generate prediction data which is used to predict an amount of consumed energy; and a prediction data generating unit configured to generate energy consumption prediction data in accordance with an instruction from the user based on the prediction data.

### TECHNICAL FIELD

The present disclosure relates to an energy consumption prediction device, an energy consumption prediction method, and an energy consumption prediction program.

### BACKGROUND ART

In the related art, using energy result information of energy used in the past to predict an amount of consumed energy is being investigated. For example, Patent Literature 1 describes that a planned value of energy which will be used in the future is set in time periods by a planned value setting means when result information of energy used in the past is displayed on a display means.

### CITATION LIST

### Patent Literature

[Patent Literature 1] Japanese Unexamined Patent Publication No. 2011-10470

### SUMMARY OF INVENTION

### Technical Problem

In the technique described in Patent Literature 1, information is acquired by designating a date when past result information is used. However, there is actually a likelihood that conditions appropriate for a target date on which an amount of consumed energy is predicted will not be extracted using only a date, and there is room for improvement in view of prediction accuracy of an amount of consumed energy.

The present disclosure is in consideration of the aforementioned circumstances, and an objective thereof is to provide a technique capable of more accurately predicting an amount of consumed energy.

### Solution to Problem

According to an aspect of the present disclosure, there is provided an energy consumption prediction device including: a storage unit configured to store past energy consumption result data of a target facility in correlation with information for identifying a date and time at which the data has been acquired and incidental information which is information related to an operation situation of the target facility when the data has been acquired; an extraction unit configured to extract data in which the incidental information matches an extraction condition designated by a user from the energy consumption result data stored in the storage unit and to generate prediction data which is used to predict an amount of consumed energy; and a prediction data generating unit configured to generate energy consumption prediction data in accordance with an instruction from the user based on the prediction data.

### Advantageous Effects of Invention

According to the present disclosure, it is possible to provide a technique capable of more accurately predicting an amount of consumed energy.

### BRIEF DESCRIPTION OF DRAWINGS

FIG. 1 is a diagram illustrating a use state of an energy consumption prediction device according to an embodiment.

FIG. 2 is a diagram schematically illustrating the energy consumption prediction device according to the embodiment.

FIG. 3(a) and FIG. 3(b) are diagrams illustrating an example of a screen associated with inputting of incidental information or the like.

FIG. 4 is a diagram illustrating an example of a screen associated with setting of extraction conditions.

FIG. 5 is a diagram illustrating an example of a screen associated with outputting of an extraction result and a predicted value.

FIG. 6 is a diagram illustrating an example of a screen associated with outputting of an extraction result and a predicted value when a specific cluster has been selected.

FIG. 7 is a flowchart illustrating an example of a routine which is performed when incidental information is input to the energy consumption prediction device.

FIG. 8 is a diagram illustrating an example of a routine of preparing energy consumption prediction data.

FIG. 9 is a diagram illustrating an example of a hardware configuration of the energy consumption prediction device.

### DESCRIPTION OF EMBODIMENTS

An energy consumption prediction device according to an aspect of the present disclosure includes: a storage unit configured to store past energy consumption result data of a target facility in correlation with information for identifying a date and time at which the data has been acquired and incidental information which is information related to an operation situation of the target facility when the data has been acquired; an extraction unit configured to extract data in which the incidental information matches an extraction condition designated by a user from the energy consumption result data stored in the storage unit and to generate prediction data which is used to predict an amount of consumed energy; and a prediction data generating unit configured to generate energy consumption prediction data in accordance with an instruction from the user based on the prediction data.

An energy consumption prediction method according to another aspect of the present disclosure includes: storing past energy consumption result data of a target facility in a storage unit in correlation with information for identifying a date and time at which the data has been acquired and incidental information which is information related to an operation situation of the target facility when the data has been acquired; extracting data in which the incidental information matches an extraction condition designated by a user from the energy consumption result data stored in the storage unit and generating prediction data which is used to predict an amount of consumed energy; and generating energy consumption prediction data in accordance with an instruction from the user based on the prediction data.

An energy consumption prediction program according to another aspect of the present disclosure causes a computer to perform: storing past energy consumption result data of a target facility in a storage unit in correlation with information for identifying a date and time at which the data has been acquired and incidental information which is information related to an operation situation of the target facility when the data has been acquired; extracting data in which the incidental information matches an extraction condition designated by a user from the energy consumption result data stored in the storage unit and generating prediction data which is used to predict an amount of consumed energy; and generating energy consumption prediction data in accordance with an instruction from the user based on the prediction data.

With the energy consumption prediction device, the energy consumption prediction method, and the energy consumption prediction program, the past energy consumption result data is stored in the storage unit in correlation with information for identifying a date and time at which the data has been acquired and incidental information which is information related to an operation situation of a target facility when the data has been acquired. Data in which the incidental information matches an extraction condition designated by a user is extracted from the data stored in the storage unit, prediction data which is used to predict an amount of consumed energy is generated, and energy consumption prediction data is generated in accordance with an instruction from the user based on the prediction data. By employing this configuration, more highly relevant data can be extracted as the prediction data, for example, by designating a condition highly relevant to a target date in which the energy consumption prediction data is generated out of the incidental information as the extraction condition. Accordingly, it is possible to more accurately predict an amount of consumed energy.

The energy consumption prediction device may further include a clustering unit configured to prepare data which is classified into a plurality of clusters by performing a clustering process on the data extracted by the extraction unit, and the prediction data generating unit may use the data classified into the plurality of clusters as the prediction data.

With only the extraction condition designated by a user, it is conceivable that the extracted data includes much unevenness. On the other hand, by classifying the data extracted by the extraction unit into a plurality of clusters through a clustering process which is performed by the clustering unit, it is possible to collect data with a similar tendency out of the extracted data. Accordingly, it is possible to more accurately predict an amount of consumed energy using the data.

The prediction data generating unit may generate the energy consumption prediction data based on the data classified into one of the plurality of clusters in accordance with an instruction from the user.

As described above, when the energy consumption prediction data is generated based on the data classified into one of the plurality of clusters in accordance with an instruction from the user, the energy consumption prediction data is generated from the data classified into one cluster and collected as the data with a similar tendency out of the extracted data. In this case, it is possible to prepare energy consumption prediction data in which the tendency of the cluster is reflected using the data with a more similar tendency classified into one cluster.

The prediction data generating unit may prepare data obtained by performing statistical processing on the prediction data and generate the energy consumption prediction data in accordance with designation of the user from the data subjected to the statistical processing.

By preparing data obtained by performing a statistical processing on the prediction data as described above, data in which features of data included in the prediction data are reflected is generated as the energy consumption prediction data.

The energy consumption prediction device may further include an input interface that allows the user to designate details of the statistical processing which is used for the energy consumption prediction data in the prediction data generating unit.

By allowing a user to designate details of the statistical processing when the energy consumption prediction data is generated, the user can flexibly designate details of the statistical processing, for example, in consideration of use conditions of the energy consumption prediction data. Accordingly, it is possible to accurately prepare energy consumption prediction data which is appropriate for an application thereof.

The energy consumption prediction device may further include a display unit, the display unit may display the data obtained by performing the statistical processing on the prediction data as a candidate for the energy consumption prediction data, and the user may be allowed to select data which is used for the energy consumption prediction data out of the candidates using the input interface.

By employing this configuration, a user can ascertain the data obtained by performing the statistical processing on the prediction data and displayed on the display unit as a candidate for the energy consumption prediction data. The user can select data which is used as the energy consumption prediction data while ascertaining the candidate. Accordingly, it is possible to enhance convenience for the user.

The energy consumption prediction device may further include a display unit, and the display unit may present the incidental information corresponding to the past energy consumption result data to a user in correspondence with a time series.

By employing this configuration, a user can ascertain time-series change of the incidental information. Since the user can ascertain whether incidental information has been input, it is possible to prompt the user to input incidental information.

Hereinafter, an embodiment of the present disclosure will be described in detail with reference to the accompanying drawings. In description with reference to the drawings, the same elements will be referred to by the same reference signs, and description thereof will not be repeated.

[Energy Consumption Prediction Device]

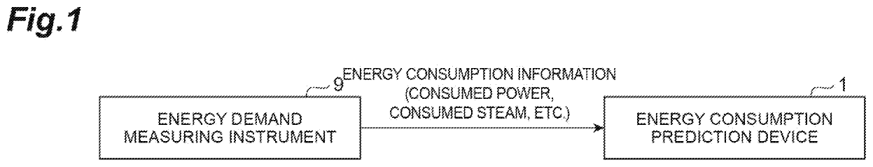

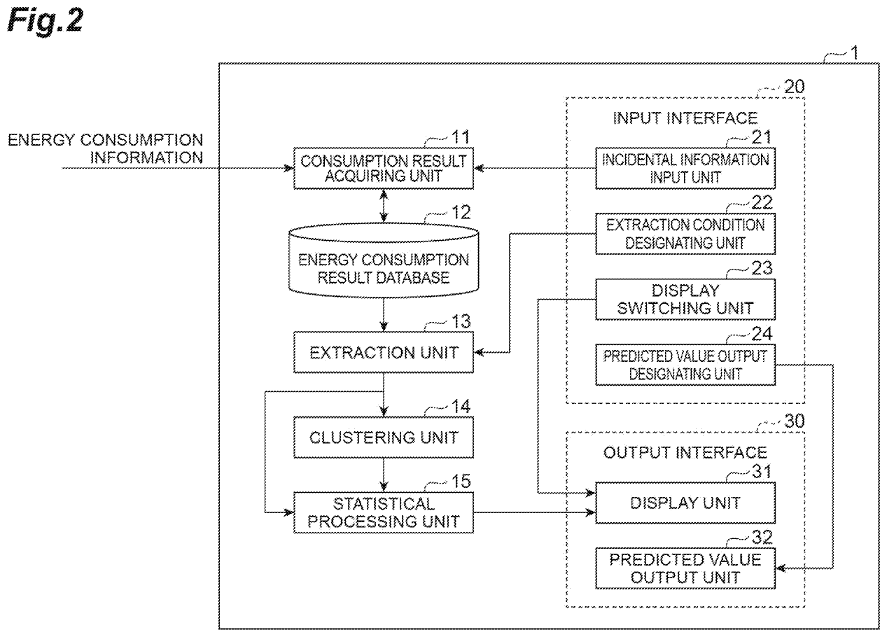

A schematic configuration of an energy consumption prediction device 1 according to an embodiment will be first described below with reference to FIGS. 1 and 2. The energy consumption prediction device 1 according to the embodiment has a function of predicting an amount of energy used in a target facility or the like in accordance with an instruction from a user. A facility which is a prediction target or the like (equipment, facility) is, for example, a factory or a plant.

As illustrated in FIG. 1, the energy consumption prediction device 1 predicts an amount of consumed energy associated with a target date and a target time period in the future based on result information associated with energy consumption from an energy demand measuring instrument 9. For example, the energy demand measuring instrument 9 measures a value of a total amount of energy such as electric power or steam consumed in the whole target facility and continuously transmits a result thereof to the energy consumption prediction device 1. A timing at which information is transmitted from the energy demand measuring instrument 9 to the energy consumption prediction device 1 is arbitrary. Information may be transmitted whenever a measured value is updated, or a method of providing a separate data storage means and transmitting data periodically (for example, every hour) together may be employed. Transmission of data may be performed via an intranet in the facility such as TCP/IP or may be performed using a method of temporarily uploading information to a server over the Internet and allowing the energy consumption prediction device to download the information. Information accumulated in the energy demand measuring instrument 9 may be manually transmitted to the energy consumption prediction device 1 using a storage medium such as a USB memory.

Constituent units of the energy consumption prediction device 1 will be described below with reference to FIG. 2. In the following description, a configuration focused particularly on an amount of consumed electric power as an amount of consumed energy will be described.

The energy consumption prediction device 1 includes, for example, a consumption result acquiring unit 11, an energy consumption result database 12, an extraction unit 13, a clustering unit 14, a statistical processing unit 15, an incidental information input unit 21, an extraction condition designating unit 22, a display switching unit 23, a predicted value output designating unit 24, a display unit 31, and a predicted value output unit 32. Among these, the incidental information input unit 21, the extraction condition designating unit 22, the display switching unit 23, and the predicted value output designating unit 24 may be configured as an input interface 20 acquiring information designated by a user. The display unit 31 and the predicted value output unit 32 may be configured as an output interface 30 outputting a part of information handled in the energy consumption prediction device 1 to a user.

The consumption result acquiring unit 11 has a function of acquiring information associated with an amount of consumed energy transmitted from the energy demand measuring instrument 9 to the energy consumption prediction device 1. The consumption result acquiring unit 11 has a function of storing acquired energy consumption results in the energy consumption result database 12 which will be described later. The consumption result acquiring unit 11 also has a function of acquiring information input via the incidental information input unit 21 which will be described later and delivering the acquired information to the energy consumption result database 12 in correlation with the information associated with an amount of consumed energy. Incidental information will be described later.

The energy consumption result database 12 (storage unit) stores information on an amount of consumed energy in the whole target facility (for example, power consumption result information) by dates and time periods. The energy consumption result database 12 also stores incidental information arbitrarily input by a user. Information stored in the energy consumption result database 12 is used to predict an amount of consumed energy associated with a target date and a target time period in the future.

The incidental information input unit 21 has a function of acquiring arbitrary incidental information which is added to the information associated with energy consumption results. The incidental information is input, for example, by a user of the energy consumption prediction device 1. The incidental information is information which is likely to affect energy consumption results and is, for example, information which can be set for each date and each time period in which energy consumption results are acquired. Examples of the incidental information include information associated with an operation state of a facility and weather information.

The extraction condition designating unit 22 acquires conditions (extraction conditions) for extracting specific data from the information stored in the energy consumption result database 12 when a process of predicting an amount of consumed energy associated with a target date and a target time period in the future is performed. The extraction conditions are designated, for example, by a user. The extraction conditions may include information which is included in the incidental information in addition to designation of a date and time. By allowing a user to designate conditions similar to those of a target date and a target time period in which prediction is performed as the extraction conditions, information more appropriate for prediction target conditions can be extracted from the information stored in the energy consumption result database 12.

The extraction unit 13 has a function of extracting data associated with past time-period energy consumption from the energy consumption result database 12 based on the extraction conditions acquired through a user's designation using the extraction condition designating unit 22. The extracted data can be used as prediction data serving as a basis of energy consumption prediction data.

The clustering unit 14 has a function of performing clustering of the data extracted by the extraction unit 13. Details of clustering will be described later, and clustering is a function of classifying a plurality of pieces of data extracted based on the extraction conditions into clusters. The data classified into clusters by the clustering unit 14 can serve as bases of energy consumption prediction data. Clustering performed by the clustering unit 14 is not necessary, and clustering may be performed, for example, by a user's designation.

The statistical processing unit 15 (a prediction data generating unit) has a function of calculating various statistics of the past time-period energy consumption extracted by the extraction unit 13 and/or the past time-period energy consumption classified into clusters by the clustering unit 14 for each time period. That is, the statistical processing unit 15 has a function of performing statistical processing on the prediction data prepared by the extraction unit 13 or the clustering unit 14. A statistic may be, for example, an average, a maximum value, a minimum value, or ±nσ (standard deviation) of time-period energy consumption results, but is not limited thereto. A calculated statistic can be used as a predicted value of an amount of consumed energy.

The display unit 31 displays the past time-period energy consumption extracted by the extraction unit 13, the past time-period energy consumption classified by the clustering unit 14, and various statistics by time periods calculated by the statistical processing unit 15 as a combination of a graph, a table, and text on a screen. Display details on the display unit 31 may be controlled in accordance with an instruction from a user acquired by the display switching unit 23.

The display switching unit 23 has a function of acquiring an instruction to switch/change details or forms displayed on the display unit. An instruction associated with switching of display details is given, for example, by a user. The display switching unit 23 instructs to change display details on the display unit 31 based on the details instructed by the user.

The predicted value output designating unit 24 has a function of acquiring information for identifying data employed as a predicted value from a user by presenting candidates for data employed as a predicted value by the user such as the time-period energy consumption, the statistics, and the like displayed on the display unit 31 to the user. The predicted value output designating unit 24 may be configured to present buttons corresponding to a series which can be employed as a predicted value by a user such as “average,” “maximum,” “minimum,” and “+1σ” to the user.

The predicted value output unit 32 (a prediction data generating unit) has a function of outputting data associated with a predicted value of an amount of consumed energy based on details designated by the user and acquired by the predicted value output designating unit 24. Examples of the output method include display on a screen and outputting as a data file to an external device or a storage medium.

An example of an output destination of the data associated with the predicted energy consumption value from the predicted value output unit 32 is a management device managing a facility or equipment in which prediction is performed. In this case, the management device serving as the output destination can perform adjustment or the like of an amount of energy supplied to the target facility or equipment using the data associated with the predicted energy consumption value. In a facility or equipment in which it is difficult to stop operation such as a factory or a plant, it may be important to supply energy for realizing stable operation. In this case, it is possible to more appropriately supply energy by utilizing the data associated with the predicted energy consumption value.

[Input and Output Interfaces]

The incidental information input unit 21, the extraction condition designating unit 22, the display switching unit 23, and the predicted value output designating unit 24 included in the input interface 20 and the display unit 31 and the predicted value output unit 32 included in the output interface 30 will be additionally described below with reference to a specific screen example.

(1) Incidental Information Input Unit

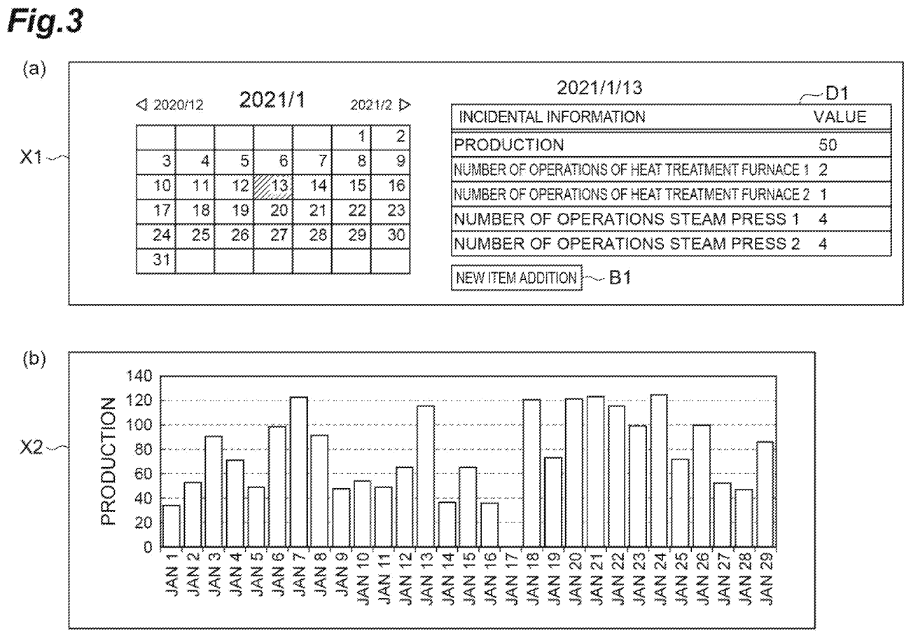

The incidental information input unit 21 is information associated with energy consumption results as described above. Specifically, examples of the incidental information include a production of products produced in the facility for each date and the number of operations or an operating time of a principal energy consuming instrument (a facility that consumes energy). In FIG. 3(a), an example of an input screen of incidental information is illustrated. In the screen example X1 illustrated in FIG. 3(a), a situation in which a date “2021/1/13” is selected from a calendar and incidental information for the date is input is shown. As items of incidental information D1 which is input for the date, a production, the numbers of operations of heat treatment furnaces 1 and 2, and the numbers of operations of steam presses 1 and 2 are shown. The items of the incidental information may be common for the dates. A configuration in which new incidental information can be set using a new item addition button B1 may be employed according to necessity.

Settings for preventing oblivion of input for each input date may be added to the incidental information input unit 21. For example, a configuration for attracting attention of a user by emphasizing a date at which incidental information has not been input in the calendar illustrated in FIG. 3(a) through coloring may be employed.

When each item of the incidental information D1 is selected, a configuration in which information associated with a time series of the input incidental information is together displayed may be employed. In FIG. 3(b), input values of productions at the dates of January including January 13 selected by a user are shown as bar graphs. When the user selects the item “production” from the incidental information D1, change in production at each date can be visually presented to the user by employing the configuration in which graphs are displayed as in the screen example X2 illustrated in FIG. 3(b). Regarding a date at which input is not performed as January 17 illustrated in FIG. 3(b), a production of zero is also displayed. Accordingly, the user can recognize a date at which there is a likelihood of oblivion of input with reference to the graphs.

The incidental information may be individually input by a user by presenting the screen illustrated in FIG. 3(a) to the user, or may be automatically acquired from an external device or the like. For example, the incidental information input unit 21 may acquire information corresponding to the incidental information by connecting the energy consumption prediction device 1 to an external device (for example, a device taking charge of operation management of the facility) and automatically downloading the information from the external device. In this case, the device configuration may be complicated, but an increase in business efficiency can be expected in addition to prevention of oblivion of input of the incidental information.

In addition to information associated with production, external factors such as weather may be able to be input as the incidental information. It is conceivable that there is a significant correlation between the temperature and energy consumption associated with air conditioning, though it may depend on the target facility. Accordingly, it is possible to expect improvement in prediction accuracy of an amount of consumed energy using information such as weather. For example, since past results of the weather information are disclosed over the Internet, the weather information may be automatically downloaded. In this way, the method of acquiring the incidental information is not limited to inputting from a user, but can be appropriately changed.

(2) Extraction Condition Designating Unit

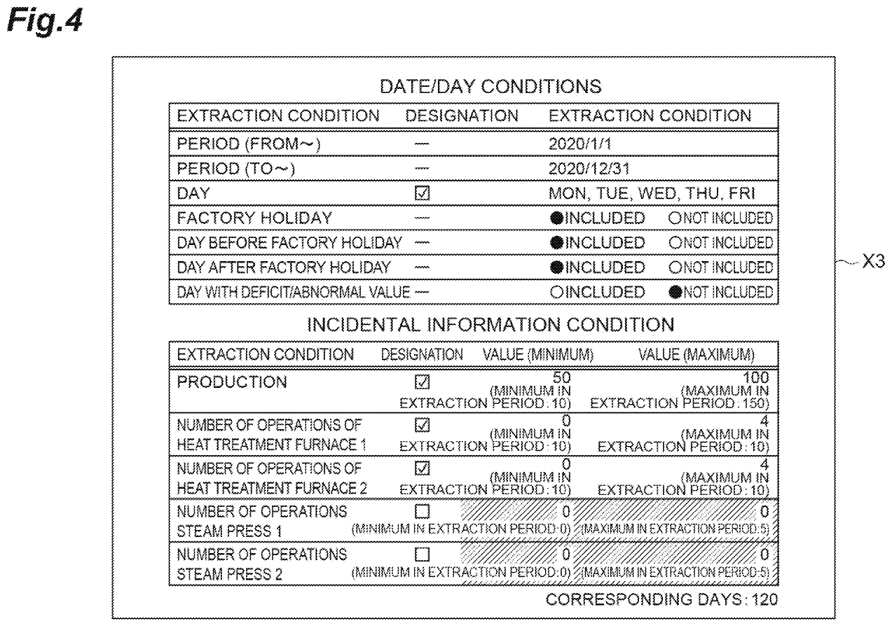

In order to extract time-period energy consumption data of a date at which a situation is similar to that at the date at which prediction is performed, the extraction condition designating unit 22 identifies data to be extracted from the past time-period energy consumption data stored in the energy consumption result database 12 based on information of date, day, and factory holiday and the incidental information. The screen example X3 illustrated in FIG. 4 is an example of a screen for designating extraction conditions. As illustrated in FIG. 4, items for designating the extraction conditions are provided for each of a “date/day input condition” and an “incidental information condition” in the screen for designating the extraction conditions.

As a method of allowing a user to designate a condition used for extraction, for example, a check box marked by “designation” may be provided in an input window and conditions described in the rows may be switched for use in extraction. Accordingly, it is possible to easily switch an extraction condition between validity and invalidity regardless of whether an item of each row is to be input. In the screen example X3 illustrated in FIG. 4, the numbers of operations of steam press 1 and steam press 2 in the incidental information are excluded from the extraction conditions. In this way, when check of “designation” is excluded (when it is excluded from the extraction conditions), nonuse of the condition may be intuitively expressed by changing the background color of the rows (for example, the column “value”). As illustrated in the screen example of FIG. 4, the number of days (illustrated as “corresponding days” in FIG. 4) matching a lower limit value or an upper limit value of the incidental information in a designated period or matching the extraction conditions designated by a user may be displayed. These numerical values can be used as reference information for allowing the user to designate the extraction conditions. That is, the user can adjust (relax or reinforce) the extraction conditions based on such information. In this way, by displaying information which can be referred to by the user together on the screen for designating the extraction conditions, designation of the extraction conditions by the user can be assisted with.

(3) Display Switching Unit and Predicted Value Output Designating Unit

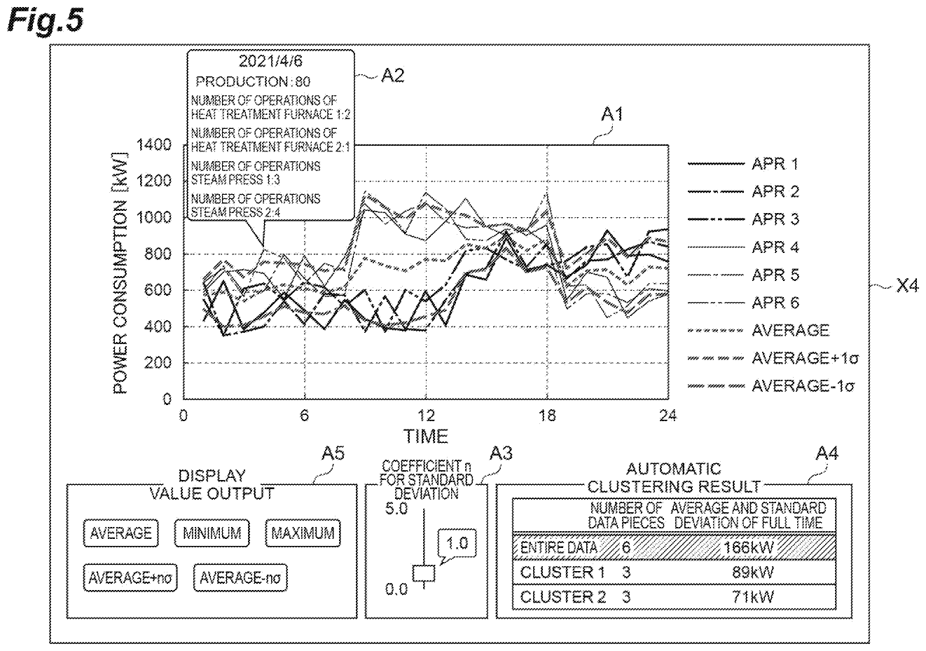

When the extraction conditions are set, data matching the extraction conditions is extracted from information stored in the energy consumption result database 12 by the extraction unit 13. This result is displayed by the display unit 31. The screen example X4 illustrated in FIG. 5 is an example of a screen which is displayed on the display unit 31. In the screen example X4, results of clustering from the clustering unit 14 and results of statistical processing from the statistical processing unit 15 are together displayed.

In an upper part of the screen example X4 illustrated in FIG. 5, past time-period energy consumption extracted under the conditions designated by a user is displayed in a graph A1 with time on the horizontal axis. In the graph A1, the extracted past time-period energy consumption is displayed such that a date thereof can be identified. In the example displayed in the screen example X4, time-period energy consumption corresponding to April 1 to April 6 is extracted and displayed. In the graph A1, “average,” “average+1σ,” and “average−1σ” are displayed together. The statistics such as the average are calculated by the statistical processing unit 15 and are calculated from the extracted data corresponding to six days.

In FIG. 5, an example in which incidental information such as a production corresponding to the date is displayed as a pop-up window A2 when one point of the data of “2021/4/6” is selected or subjected to mouse-over is illustrated. In this way, the date and time, the incidental information, and the like may be able to be displayed when each series in the graph A1 is selected or subjected to mouser-over. In this case, a user can individually ascertain a relationship between each piece of data and the incidental information of the data while ascertaining time-series fluctuation of the power consumption results in the graph A1.

As described above, a series of an average and an average±σ of time-period energy consumption is also displayed in the graph A1. Here, n is a coefficient associated with a standard deviation. A state of n=1 is displayed in the graph A1, but the value of n may be changed. In the screen example X4, a frame A3 of standard deviation coefficient n is provided as an example of a constituent of the display switching unit 23, and a slider capable of changing n is provided in the frame. When the slider is operated by a user, “average±no” which is calculated using n corresponding to the position of the slider may be displayed as a statistic which is displayed in the graph A1. In this way, display details which are displayed in the graph A1 by the display unit 31 may be changed based on a result of calculation from the statistical processing unit 15 according to the position of the slider serving as the display switching unit 23.

The display switching unit 23 may be configured to automatically update the graph A1 in the step in which the operation of the slider in the frame A3 of standard deviation coefficient n is detected.

In the screen example X4, a frame A4 of automatic clustering result is displayed as another constituent of the display switching unit 23. The number of pieces of constituent data of clusters (clusters 1 and 2) generated by the clustering unit 14 or a value of full-time average and standard deviation in each cluster in addition to the conditions (whole data) designated by the user is displayed in the frame A4 of automatic clustering result.

The clustering process which is performed by the clustering unit 14 will be described below. The clustering process is a process of classifying consumption result data extracted under the extraction conditions into a plurality of clusters. As described above, the consumption result data used to predict an amount of consumed energy is extracted by allowing a user to set various extraction conditions. However, when the conditions set by the user are not appropriate such as when the conditions have a large range, when the user does not set a specific extraction setting condition, or when data changes greatly due to a condition which is not originally assumed for the energy consumption prediction device 1, there is a likelihood that all of the extracted data will not exhibit the same tendency and a bias will occur. In this case, by performing the clustering process to classify the extracted consumption result data into a plurality of clusters, presence of a bias of the plurality of pieces of extracted consumption result data or the classified clusters can be presented to the user.

An algorithm used for the clustering process is not particularly limited and, for example, a k-means method which is an unsupervised machine learning method may be employed. When the k-means method is employed, vectors in which everyday time-period energy consumption and incidental information are arranged are conceivable, and these vectors are clustered. Specifically, for example, it is assumed that time periods of one day are defined by 24 points every hour and five items including a production, the number of operations of heat treatment furnace 1, the number of operations of heat treatment furnace 2, the number of operations of steam press 1, and the number of operations of steam press 2 are considered as incidental information. In this case, the number of dimensions (the number of factors) of each vector of the data is 24+5=29. Clustering is performed by repeatedly calculating classification using the center of gravity of clusters and movement of the center of gravity to classify the vectors of data acquired in this way. When the k-means method is performed, results are affected by a range of the data and thus a pre-process (such as normalization of a value range) may be performed according to necessity. When the k-means method is performed, it is necessary to designate the number of clusters. The number of clusters may be a program parameter or may be determined every time by a user. The number of clusters may be set to be determined in consideration of a degree of dispersion of the extracted data. The number of clusters may be set to 2 to 3 in consideration of analysis capability of results.

In the frame A4 of automatic clustering result illustrated in FIG. 5, two clusters 1 and 2 are displayed. When a user selects a specific cluster in the frame, the graph A1 may be re-displayed such that only time-period energy consumption data of the selected cluster is displayed.

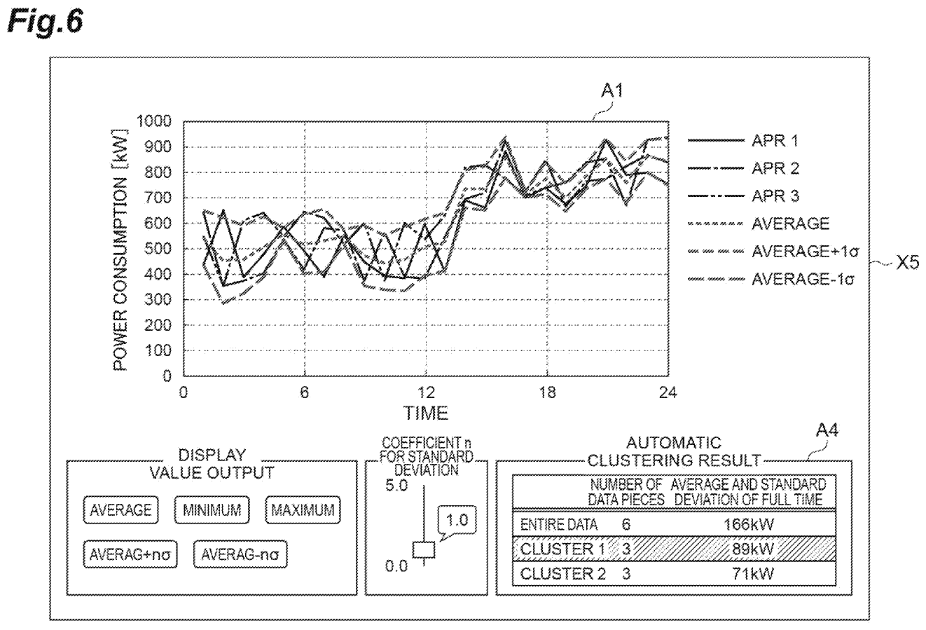

A screen example X5 illustrated in FIG. 6 shows a state in which cluster 1 is selected in the frame A4 of automatic clustering result in the screen example X4. In the screen example X5, results of three pieces of data (April 1 to 3) classified into cluster 1, an average thereof, and an average±1σ thereof are displayed in the graph A1 as the result of selection of cluster 1. When a user instructs to display a cluster obtained as the result of the clustering process in this way, the display unit 31 may change display details displayed in the graph A1 based on the result of calculation from the statistical processing unit 15 in accordance with an instruction from the user.

The clustering result from the clustering unit 14 is particularly effective when data is uneven due to factors not included in the extraction conditions designated by the user. When this configuration is employed, the user can ascertain whether a situation of a target date matches the incidental information of data of the clusters and then determine a predicted value of time-period energy consumption of the target date, for example, using only data included in a specific cluster. That is, when unevenness of the extracted data occurs due to factors which have not been considered by the user, the unevenness of data can be excluded to a certain extent through clustering and data to be used for prediction can be prepared.

The example of the display switching unit 23 is not limited to the example in the screen example X4 illustrated in FIG. 5. For example, various functions for providing visibility of a graph such as functions for changing enlargement/reduction scales of a graph and switching a specific series between display and non-display may be provided as the display switching unit 23.

In the screen example X4 illustrated in FIG. 5, a frame A5 of display value output corresponding to the predicted value output designating unit 24 is displayed. In the frame, a button group for outputting a predicted value of time-period energy consumption of the target date from a series of statistics displayed therein by one click is provided. For example, in the screen example X4, “average,” “minimum,” “maximum,” “average+nσ,” and “average−nσ” are provided. When the user clicks one of the button group, the corresponding predicted value of time-period energy consumption is output by the predicted value output unit 32. The output destination may be a screen or a file. The predicted value may be recorded on a main storage of a computer based on the premise of cooperation with another program.

In the frame A5 of display value output, a button different from the buttons illustrated in FIG. 5 may be set. For example, when data of a specific date in the energy consumption result data extracted as the predicted energy consumption values is assumed to be used without any change, the configuration or the like of the predicted value output designating unit 24 may be changed such that the data can be output as a predicted value. That is, a type of data which is output as the energy consumption prediction data is not limited to data subjected to the statistical processing and displayed in the frame A5 of display value output, and one piece of the prediction data may be used as the energy consumption prediction data.

[Energy Consumption Prediction Method]

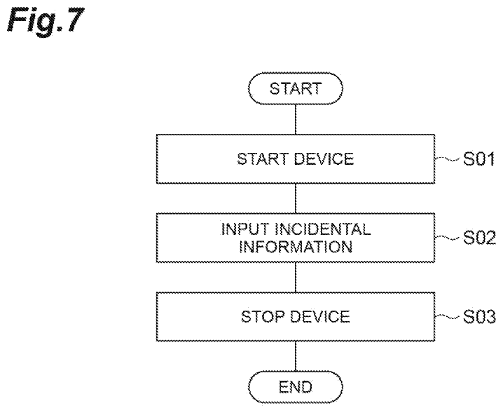

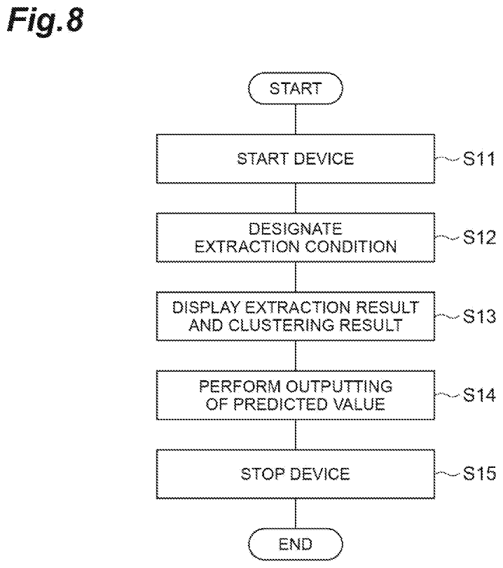

An energy consumption prediction method which is performed by the energy consumption prediction device 1 will be described below with reference to FIGS. 7 and 8. FIG. 7 illustrates a routine used for inputting incidental information to the energy consumption prediction device 1, and FIG. 8 illustrates a routine used for preparing energy consumption prediction data.

The routine used for inputting incidental information to the energy consumption prediction device 1 will be described with reference to FIG. 7. As the premise, it is first assumed that result data associated with an amount of consumed energy is transmitted from the energy demand measuring instrument 9 to the energy consumption prediction device 1 and is stored in the energy consumption result database 12. Then, a routine used for allowing a user or the like to add incidental information is performed.

First, the user activates the energy consumption prediction device 1 (Step S01). Then, the user inputs incidental conditions corresponding to energy consumption result data using the incidental information input unit 21 of the input interface 20 (Step S02). Thereafter, the user deactivates the energy consumption prediction device 1 (Step S03).

A routine used for generating energy consumption prediction data of an estimation target date using the energy consumption prediction device 1 will be described below with reference to FIG. 8. First, as the premise, it is assumed that data is stored in the energy consumption result database 12 of the energy consumption prediction device 1 in a state in which incidental information is correlated with the energy consumption result data.

First, a user activates the energy consumption prediction device 1 (Step S11). Then, the user sets extraction conditions for generating energy consumption prediction data of a target date using the extraction condition designating unit 22 of the input interface 20 (Step S12).

Then, the energy consumption prediction device 1 causes the extraction unit 13 to extract consumption result data based on the extraction conditions designated by the extraction condition designating unit 22, performs clustering thereon, and displays the clustering result and a statistical processing result (Step S13). In this step, the extraction unit 13 of the energy consumption prediction device 1 extracts consumption result data required for preparing prediction data. The clustering unit 14 performs clustering of the extracted consumption result data based on preset conditions according to necessity. The statistical processing unit 15 performs statistical processing on the extracted consumption result data and the data classified through the clustering and calculates statistical data such as an average, an average±nσ, a maximum, and a minimum. This data is displayed on the display unit 31. As a result, the user can ascertain the extracted data, the statistical processing result, and the like. At this time, the user may perform an operation such as changing display details on the display unit 31 by operating the display switching unit 23.

In this way, in the energy consumption prediction device 1, generation of prediction data using the extraction unit 13 and the clustering unit 14 and statistical processing of the prediction data using the statistical processing unit 15 are simultaneously performed. With this device configuration in which energy consumption prediction data is generated while a user is ascertaining data displayed on the display unit 31, the generation of prediction data and the statistical processing may be simultaneously performed. Until the user finally determines data to be output as the energy consumption prediction data (Step S14), the statistical processing using the statistical processing unit 15 may be repeatedly performed in accordance with the user's instruction.

Then, the user instructs to generate prediction data to be output using the predicted value output designating unit 24 of the input interface 20 (Step S14). Designation using the predicted value output designating unit 24 is performed, for example, by allowing the user to operate the frame A5 of display value output in the screen example X4. Based on the instruction from the user, the predicted value output unit 32 of the energy consumption prediction device 1 prepares and outputs prediction data. Thereafter, the user deactivates the energy consumption prediction device 1 (Step S15).

[Hardware Configuration]

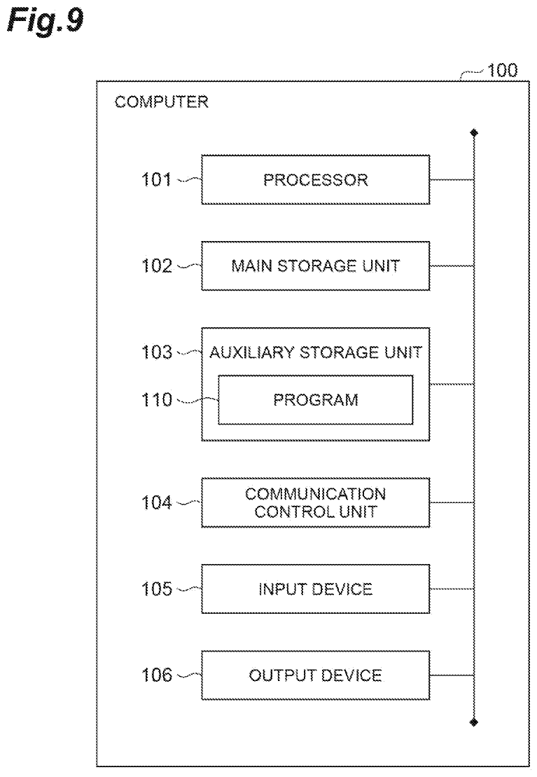

A hardware configuration of the energy consumption prediction device 1 will be described below with reference to FIG. 9. FIG. 9 is a diagram illustrating an example of the hardware configuration of the energy consumption prediction device 1. The energy consumption prediction device 1 includes one or more computers 100. The computer 100 includes a central processing unit (CPU) 101, a main storage unit 102, an auxiliary storage unit 103, a communication control unit 104, an input device 105, and an output device 106. The energy consumption prediction device 1 is constituted by one or more computers 100 including such hardware and software such as programs.

When the energy consumption prediction device 1 is constituted by a plurality of computers 100, the computers 100 may be locally connected or may be connected via a communication network such as the Internet or an intranet. The energy consumption prediction device 1 which is logically single is constructed by such connection.

The CPU 101 executes an operating system, an application program, or the like. The main storage unit 102 includes a read only memory (ROM) and a random access memory (RAM). The auxiliary storage unit 103 is a storage medium including a hard disk and a flash memory. The auxiliary storage unit 103 stores a larger amount of data than the main storage unit 102 in general. At least a part of constituents of the energy consumption prediction device 1 are realized by the auxiliary storage unit 103. The communication control unit 104 is constituted by a network card or a radio communication module. At least a part of constituents of the energy consumption prediction device 1 may be realized by the communication control unit 104. The input device 105 includes a keyboard, a mouse, a touch panel, and a speech-input microphone. For example, at least a part of the input interface 20 is realized by the input device 105. The output device 106 includes a display and a printer. At least a part of the output unit 19 is realized by the output device 106. For example, the output device 106 may display prediction value data or the like output from the output interface 30 on the display or the like.

The auxiliary storage unit 103 stores a program 110 and data required for processing in advance. The program 110 causes the computer 100 to perform functional elements of the energy consumption prediction device 1. In accordance with the program 110, for example, processes associated with Steps S01 to S04 are performed by the computer 100. For example, the program 110 is read by the CPU 101 or the main storage unit 102 to operate at least one of the CPU 101, the main storage unit 102, the auxiliary storage unit 103, the communication control unit 104, the input device 105, and the output device 106. For example, the program 110 performs reading and writing of data from and to the main storage unit 102 and the auxiliary storage unit 103.

The program 110 may be stored in a material recording medium such as a CD-ROM, a DVD-ROM, or a semiconductor memory and then provided. The program 110 may be provided as data signals via a communication network.

[Operations]

With the energy consumption prediction device 1, the energy consumption prediction method, and the energy consumption prediction program, the past energy consumption result data is stored in the storage unit in correlation with information for identifying a date and time at which the data has been acquired and incidental information which is information related to an operation situation of a target facility when the data has been acquired. Data in which the incidental information matches an extraction condition designated by a user is extracted from the data stored in the storage unit, prediction data which is used to predict an amount of consumed energy is generated, and energy consumption prediction data is generated in accordance with an instruction from the user based on the prediction data. By employing this configuration, more highly relevant data can be extracted as the prediction data, for example, by designating a condition highly relevant to a target date in which the energy consumption prediction data is generated out of the incidental information as the extraction condition. Accordingly, it is possible to more accurately predict an amount of consumed energy.

A configuration for extracting the energy consumption result data by designating a date and time is known in the related art, but it may be difficult to appropriately extract result data matching a situation in which the energy consumption prediction data is prepared using only the date and time information. In this regard, by employing the configuration for combination with incidental information as described above, accuracy of data which is extracted as the prediction data can be enhanced and thus it is possible to prepare more accurate energy consumption prediction data.

With only the extraction condition designated by a user, it is conceivable that the extracted data include much unevenness. On the other hand, the energy consumption prediction device may further include the clustering unit 14 configured to prepare data which is classified into a plurality of clusters by performing a clustering process on the data extracted by the extraction unit 13. The statistical processing unit 15 and the predicted value output unit 32 which are the prediction data generating unit may also use the data classified into the plurality of clusters as the prediction data. It is possible to collect data with similar tendency out of the data extracted through the clustering process which is performed by the clustering unit 14. Accordingly, it is possible to more accurately predict an amount of consumed energy using the data.

The prediction data generating unit may generate the energy consumption prediction data based on the data classified into one of the plurality of clusters in accordance with an instruction from the user. In this case, the energy consumption prediction data is generated from the data classified into one cluster and collected as the data with similar tendency out of the extracted data. By employing this configuration, it is possible to prepare energy consumption prediction data in which the tendency of the cluster is reflected using the data with more similar tendency classified into one cluster.

The statistical processing unit 15 and the predicted value output unit 32 which serve as the prediction data generating unit may prepare data obtained by performing statistical processing on the prediction data and generate the energy consumption prediction data in accordance with designation of the user from the data subjected to the statistical processing. By preparing data obtained by performing a statistical processing on the prediction data as described above, data in which features of data included in the prediction data are reflected is generated as the energy consumption prediction data.

The energy consumption prediction device may further include the input interface 20 that allows a user to designate details of the statistical processing which is used for the energy consumption prediction data in the prediction data generating unit. By allowing a user to designate details of the statistical processing when the energy consumption prediction data is generated, the user can flexibly designate details of the statistical processing, for example, in consideration of use conditions of the energy consumption prediction data. Accordingly, it is possible to accurately prepare energy consumption prediction data which is appropriate for an application thereof.

The energy consumption prediction device may further include the display unit 31, and the display unit 31 may display the data obtained by performing the statistical processing on the prediction data as a candidate for the energy consumption prediction data. A user may be allowed to select data which is used for the energy consumption prediction data out of the candidates using the input interface 20. By employing this configuration, a user can ascertain the data obtained by performing the statistical processing on the prediction data and displayed on the display unit 31 as a candidate for the energy consumption prediction data. The user can select data which is used as the energy consumption prediction data while ascertaining the candidate. Accordingly, it is possible to enhance convenience for the user.

The energy consumption prediction device may further include the display unit 31, and the display unit 31 may present the incidental information corresponding to the past energy consumption result data to a user in correspondence with a time series as illustrated in the screen example X2. By employing this configuration, a user can ascertain time-series change of the incidental information. Since the user can ascertain whether incidental information has been input, it is possible to prompt the user to input incidental information.

### Modified Examples

The present disclosure is not limited to the aforementioned embodiments and can be modified in various forms without departing from the gist thereof.

For example, electric power is handled as energy in the aforementioned embodiments, but a plurality of types of energy may be handled together. For example, it is conceivable that electric power and steam be handled. In this case, for example, information on a plurality of types of energy may be simultaneously displayed in the graph A1 which is displayed in the screen example X4. For example, when two types of energy of electric power and steam are predicted, two graphs may be arranged or the two graphs may be switched using a button or the like. In this case, the screen example described in the aforementioned embodiments is only an example and can be flexibly changed depending on a prediction target, consumption result data, incidental information, and the like.

Examples of energy to which the present disclosure can be applied include energy such as electric power or steam which can be directly used as power and substance which can be converted thereto or to which the energy can be converted. Specific examples of energy include water and hydrogen. Fuel such as methane or ammonia which is synthesized from hydrogen is included as energy in the present disclosure.

The facility or equipment in which an amount of consumed energy is predicted by the energy consumption prediction device 1 and which has been described above in the embodiments is not particularly limited as long as it much handles consumption/generation of energy such as a factory or a plant described above in the embodiments. Examples of such facility or equipment include a facility or equipment for manufacturing hydrogen, methane, or ammonia according to demand therefor. Energy devices (devices handling energy) in the target facility or equipment may not be necessarily physically located close to each other. For example, when a facility for manufacturing hydrogen using photovoltaic power generation is an energy consumption prediction target, a hydrogen manufacturing facility and a photovoltaic power generation facility may be located at distant positions.

The time period corresponding to an amount of consumed energy is not limited to one hour. For example, 30 minutes which serves as a reference for power supply/demand simultaneous commensurate control may be set as one time period. Prediction of one week (7 days) with one day as one time period may be performed.

In the aforementioned embodiments, a user performs designation of the extraction conditions or the predicted value output from time to time, but a configuration for storing and calling operation details by a user (extraction conditions or extraction results) may be employed.

The configuration described above in the embodiments may be assembled as one function of an energy management system. Specifically, an operation plan of an energy device may be optimized based on the predicted energy consumption value acquired using the technique described above in the embodiments. In this case, the predicted energy consumption value may be input to the energy management system, and a power generation plan in a power generation facility which is managed by the energy management system and a charging/discharging plan in a power storage facility, or the like may be made and changed based on the predicted energy consumption value. Accordingly, it is possible to realize control using a predicted energy consumption value with high accuracy in the energy management system. The predicted energy consumption value acquired by the energy consumption prediction device 1 or the operation plan of the energy management system calculated based on the predicted energy consumption value may be transmitted directly from the energy consumption prediction device to another energy device (such as a storage battery, a gas turbine generator, or a boiler). In this case, the energy device which is a transmission destination may change control details based on the predicted energy consumption value or the operation plan.

[Others]

Regarding a prediction error of an operation plan for an energy device, fossil fuel of a gas turbine generator or the like is often adjusted for use, and a partial power operation with a margin in both an upper limit and a lower limit needs to be performed at that time. This is not a preferable operation in view of power generation efficiency and can be cause of an increase in power generation unit price, an increase in an amount of discharged CO₂, or the like. Accordingly, the present disclosure is not associated with economics or business profitability of a microgrid, but the present disclosure is associated with economic energy supply or environmental load reduction over the whole society and contributes to Goal 7 “to guarantee all people's access to cheap, reliable, and sustainable modern energy” and Goal 13 “to seek for an urgent countermeasure for reducing climate change and an influence thereof” of sustainable development goals (SDGs) which are led by the UN.

### ADDITIONAL REMARKS

The present disclosure employs the following configurations.

[1] An energy consumption prediction device including:
a storage unit configured to store past energy consumption result data of a target facility in correlation with information for identifying a date and time at which the data has been acquired and incidental information which is information related to an operation situation of the target facility when the data has been acquired;
an extraction unit configured to extract data in which the incidental information matches an extraction condition designated by a user from the energy consumption result data stored in the storage unit and to generate prediction data which is used to predict an amount of consumed energy; and
a prediction data generating unit configured to generate energy consumption prediction data in accordance with an instruction from the user based on the prediction data.

[2] The energy consumption prediction device according to [1], further including a clustering unit configured to prepare data which is classified into a plurality of clusters by performing a clustering process on the data extracted by the extraction unit,
wherein the prediction data generating unit uses the data classified into the plurality of clusters as the prediction data.

[3] The energy consumption prediction device according to [2], wherein the prediction data generating unit generates the energy consumption prediction data based on the data classified into one of the plurality of clusters in accordance with an instruction from the user.

[4] The energy consumption prediction device according to any one of [1] to [3], wherein the prediction data generating unit prepares data obtained by performing statistical processing on the prediction data and generates the energy consumption prediction data in accordance with designation of the user from the data subjected to the statistical processing.

[5] The energy consumption prediction device according to [4], further including an input interface that allows the user to designate details of the statistical processing which is used for the energy consumption prediction data in the prediction data generating unit.

[6] The energy consumption prediction device according to [5], further including a display unit,
wherein the display unit displays the data obtained by performing the statistical processing on the prediction data as a candidate for the energy consumption prediction data, and
wherein the user is allowed to select data which is used for the energy consumption prediction data out of the candidates using the input interface.

[7] The energy consumption prediction device according to any one of [1] to [6], further including a display unit.
wherein the display unit presents the incidental information corresponding to the past energy consumption result data to the user in correspondence with a time series.

[8] An energy consumption prediction method including:
storing past energy consumption result data of a target facility in a storage unit in correlation with information for identifying a date and time at which the data has been acquired and incidental information which is information related to an operation situation of the target facility when the data has been acquired;
extracting data in which the incidental information matches an extraction condition designated by a user from the energy consumption result data stored in the storage unit and generating prediction data which is used to predict an amount of consumed energy; and
generating energy consumption prediction data in accordance with an instruction from the user based on the prediction data.

[9] An energy consumption prediction program causing a computer to perform:
storing past energy consumption result data of a target facility in a storage unit in correlation with information for identifying a date and time at which the data has been acquired and incidental information which is information related to an operation situation of the target facility when the data has been acquired;
extracting data in which the incidental information matches an extraction condition designated by a user from the energy consumption result data stored in the storage unit and generating prediction data which is used to predict an amount of consumed energy; and
generating energy consumption prediction data in accordance with an instruction from the user based on the prediction data.

### REFERENCE SIGNS LIST

1 Energy consumption prediction device
11 Consumption result acquiring unit
12 Energy consumption result database (storage unit)
13 Extraction unit
14 Clustering unit
15 Statistical processing unit (prediction data generating unit)
20 Input interface
21 Incidental information input unit
22 Extraction condition designating unit
23 Display switching unit
24 Predicted value output designating unit
30 Output interface
31 Display unit
32 Predicted value output unit

1: An energy consumption prediction device comprising:
a storage unit configured to store past energy consumption result data of a target facility in correlation with information for identifying a date and time at which the data has been acquired and incidental information which is information related to an operation situation of the target facility when the data has been acquired;
an extraction unit configured to extract data in which the incidental information matches an extraction condition designated by a user from the energy consumption result data stored in the storage unit and to generate prediction data which is used to predict an amount of consumed energy; and
a prediction data generating unit configured to generate energy consumption prediction data in accordance with an instruction from the user based on the prediction data.

2: The energy consumption prediction device according to claim 1, further comprising a clustering unit configured to prepare data which is classified into a plurality of clusters by performing a clustering process on the data extracted by the extraction unit,
wherein the prediction data generating unit uses the data classified into the plurality of clusters as the prediction data.

3: The energy consumption prediction device according to claim 2, wherein the prediction data generating unit generates the energy consumption prediction data based on the data classified into one of the plurality of clusters in accordance with an instruction from the user.

4: The energy consumption prediction device according to claim 1, wherein the prediction data generating unit prepares data obtained by performing statistical processing on the prediction data and generates the energy consumption prediction data in accordance with designation of the user from the data subjected to the statistical processing.

5: The energy consumption prediction device according to claim 4, further comprising an input interface that allows the user to designate details of the statistical processing which is used for the energy consumption prediction data in the prediction data generating unit.

6: The energy consumption prediction device according to claim 5, further comprising a display unit,
wherein the display unit displays the data obtained by performing the statistical processing on the prediction data as a candidate for the energy consumption prediction data, and
wherein the user is allowed to select data which is used for the energy consumption prediction data out of the candidates using the input interface.

7: The energy consumption prediction device according to claim 1, further comprising a display unit,
wherein the display unit presents the incidental information corresponding to the past energy consumption result data to the user in correspondence with a time series.

8: An energy consumption prediction method comprising:
storing past energy consumption result data of a target facility in a storage unit in correlation with information for identifying a date and time at which the data has been acquired and incidental information which is information related to an operation situation of the target facility when the data has been acquired;
extracting data in which the incidental information matches an extraction condition designated by a user from the energy consumption result data stored in the storage unit and generating prediction data which is used to predict an amount of consumed energy; and
generating energy consumption prediction data in accordance with an instruction from the user based on the prediction data.

9: A non-transitory computer-readable recording medium storing an energy consumption prediction program causing a computer to perform:
storing past energy consumption result data of a target facility in a storage unit in correlation with information for identifying a date and time at which the data has been acquired and incidental information which is information related to an operation situation of the target facility when the data has been acquired;
extracting data in which the incidental information matches an extraction condition designated by a user from the energy consumption result data stored in the storage unit and generating prediction data which is used to predict an amount of consumed energy; and
generating energy consumption prediction data in accordance with an instruction from the user based on the prediction data.
